(19) United States
(12) Patent Application Publication
(10) Pub. No.: US 2009/0320483 A1
(43) Pub. Date: Dec. 31, 2009

(54) Variable Orifice Plug for Turbine Fuel Nozzle

(75) Inventors: James Michael Storey, Houston, TX (US); Thomas Edward Johnson, Greer, SC (US); Jesse Stewart, Taylors, SC (US); Sarah Hutcherson, Greer, SC (US)

Correspondence Address: SUTHERLAND ASBILL & BRENNAN LLP, 999 PEACHTREE STREET, N.E., ATLANTA, GA, 30309, US

(73) Assignee: General Electric Company, Schenectady, NY (US)

(21) Appl. No.: 12/146,646

(22) Filed: Jun. 26, 2008

(51) Int. Cl. F02C 1/00

(52) U.S. Cl. 60/747; 239/390

(57) ABSTRACT

A fuel nozzle for use about an end cap of a combustor. The fuel nozzle may include a flange attached to the end cap, an aperture extending through the flange, a plug positioned in the aperture, and an orifice positioned within the plug.

### TECHNICAL FIELD

The present application relates generally to gas turbine engines and more particularly relates to a variable orifice plug for use about a flange of a combustor fuel nozzle.

### BACKGROUND OF THE INVENTION

Generally described, a gas turbine ignites a fuel/air mixture in a combustor and generates a combustion gas stream. The gas stream is channeled to a turbine via a hot gas path. Compressed air is channeled to the combustor by a compressor. The combustor generally has a fuel nozzle to facilitate fuel and air delivery to a combustion region. The turbine converts the thermal energy of the combustion gas stream to mechanical energy. The mechanical energy rotates a turbine shaft that may be used to power a generator or other type of load.

Fuel may be provided to the fuel nozzle via a fuel insert body. The fuel insert body may be attached to an end cap and positioned upstream of the fuel nozzle. The fuel insert body may have a number of apertures drilled therein. These apertures may be filled with a plug defining one or more orifices. The orifices may be used to meter the fuel flowing to the nozzle.

One drawback with these inserts is that it is necessary to flow a complete end cap/fuel nozzle assembly to test the flow therethrough so as to create a flow matched set of complete end cap assemblies for a given gas turbine. This testing may take several iterations with different combinations of fuel nozzles mounted to the end caps. Such testing may require a significant amount of time.

In cases where the end caps are not used, holes may be drilled into the bottom of the fuel nozzle. The size of the hole may depend upon the size of the specified fuel nozzle group. As a result, a vender may need to build several differently sized groups of nozzles.

There is thus a desire for a simplified fuel nozzle orifice design. Such a design preferably should be easy to test and should provide versatility in selecting the flow rate therethrough.

### SUMMARY OF THE INVENTION

The present application thus provides a fuel nozzle for use about an end cap of a combustor. The fuel nozzle may include a flange attached to the end cap, an aperture extending through the flange, a plug positioned in the aperture, and an orifice positioned within the plug.

The present application further provides a combustor for a gas turbine. The combustor may include an end cap, a number of fuel nozzles positioned about the end cap with each of the fuel nozzles including a flange attached to the end cap, and a number of variable orifice plugs positioned with the flange.

The present application further provides a method of operating a combustor. The method includes positioning a number of fuel nozzles about an end cap of the combustor, flowing fuel through the fuel nozzles, and replacing one or more of the fuel nozzles without removing all of the fuel nozzles.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a side cross-sectional view of a gas turbine engine as may be used herein.

FIG. 2 is a side cross-sectional view of an end cap/fuel nozzle assembly of the gas turbine engine of FIG. 1.

FIG. 3 is a side cross-sectional view of the fuel nozzle with an orifice plug as is described herein.

FIG. 4 is a side cross-sectional view of the orifice plug of FIG. 3 positioned within the flange as is described herein.

### DETAILED DESCRIPTION

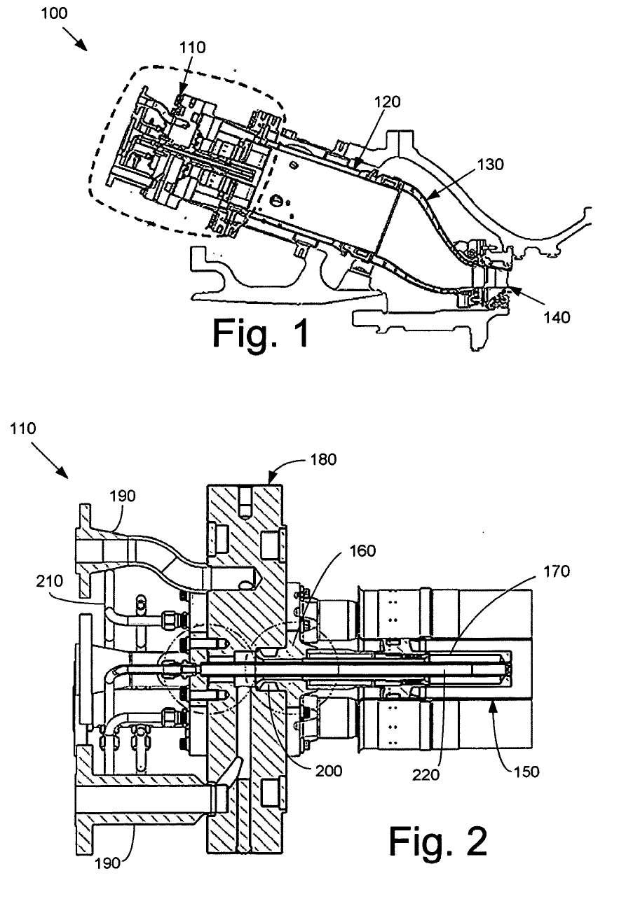

Referring now to the drawings, in which like numerals refer to like elements through the several views, FIG. 1 shows an example of a gas turbine combustion section 100. The combustor 100 may include a combustor head end arrangement 110. The combustor head end arrangement 110 will be discussed in more detail below. Generally described, the combustor 100 also may include a combustion liner 120, a transition piece assembly 130, and a turbine connection 140. Other configurations of the combustor 100 may be used herein.

FIG. 2 shows the combustor head end arrangement 110 in detail. The combustor head end arrangement 110 may include a fuel nozzle 150. The fuel nozzle 150 as shown is a 52E fuel nozzle sold by the General Electric Company of Schenectady, N.Y. Other types of fuel nozzles 150 may be used herein. The fuel nozzle 150 may include a flange 160 and a tube section 170. The fuel nozzle 150 may be positioned about an end cap 180 and attached thereto. The fuel nozzle 150 may be in communication with one or more fuel supply feeds 190. The fuel supply feeds 190 provide fuel to a fuel annulus 200 positioned about the flange 160 of the fuel nozzle 150. A number of air supply tubes 210 may supply air through the fuel nozzle 150 via an inner atomized air tube 220. Other combustor configurations may be used herein.

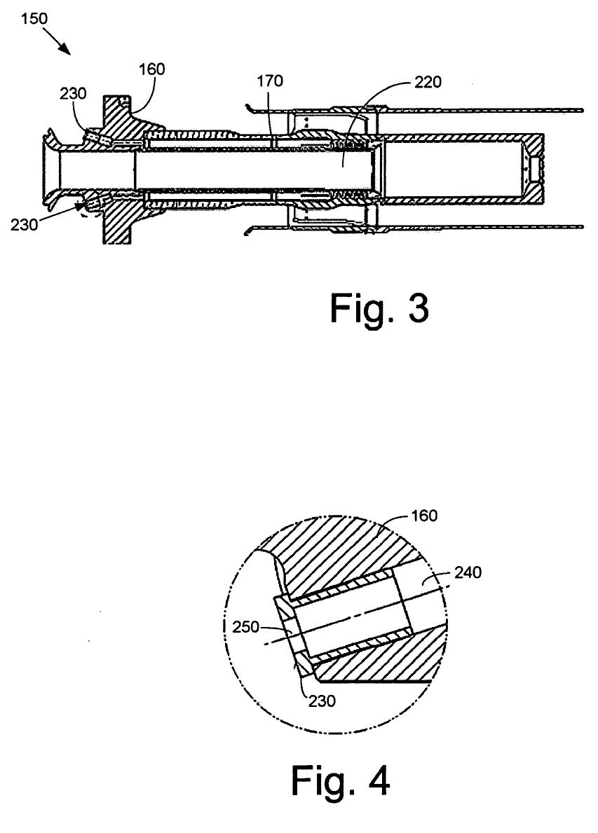

FIG. 3 is a side cross-sectional view of the fuel nozzle 150. As is shown, an orifice plug 230 may be positioned within an aperture 240 of the flange 160. In this example, ten (10) orifice plugs 230 and apertures 240 may be used although any number or orientation may be used herein. The orifice plug 230 leads to the tube section 170. The orifice plug 230 may be installed within the aperture 240 via a press fit or a screw-in manner. Other attachment means may be used herein. The orifice plug 230 may be pressure loaded such that it remains within the flange 160.

FIG. 4 shows the orifice plug 230 within the aperture 240 of the flange 160. As is shown, the orifice plug 230 has an orifice 250 defined therein. The position of the orifice 250 may vary along the plug 230. Likewise, the size and configuration of the orifice 250 and the orifice plug 230 as a whole may vary.

By positioning the orifice plugs 230 directly within the flange 160 of the fuel nozzle 150, more meaningful flow tests may be available. Specifically, the individual fuel nozzles 150 may now be flowed. The individual nozzles 150 may be replaced without having to reflow the entire end cap assembly 110. Moreover, the position and size of the orifice 250 may be modified to suit various fuel operating conditions or scenarios. The volume ratio has been shown to be linked to combustor operational dynamics such that varying the position of the orifice 250 may allow for additional tuning capability. The variable orifice 250 not only offers orifice sizing design tuning but also the location of the orifice 250 within the plug 230 may allow for tuning of the flow chamber volumes both upstream and downstream of the orifice 250.

Moreover, having a number of differently sized nozzles 150 may not be required. Rather, multiple standard apertures 240 may be used with varying designs for the orifice plugs 230 to provide the correct flow. Improved flow control should reduce variation in emissions and combustion dynamics.

It should be apparent that the foregoing relates only to certain embodiments of the present application and that numerous changes and modifications may be herein by one of ordinary skill in the art without departing from the general spirit and scope of the invention as defined by the following claims and the equivalents thereof.

1. A fuel nozzle system for use about combustor, comprising:
an end cap;
a fuel nozzle positioned about the end cap;
a flange attached to the fuel nozzle;
an aperture extending through the flange;
a plug positioned in the aperture; and
an orifice positioned within the plug.

2. The fuel nozzle system of claim 1, further comprising a plurality of apertures and a plurality of plugs.

3. The fuel nozzle system of claim 1, wherein the plug comprises a replaceable plug.

4. The fuel nozzle system of claim 1, further comprising a plurality of plugs with differently configured orifices.

5. The fuel nozzle system of claim 1, wherein the plug comprises a press fit into the aperture.

6. The fuel nozzle system of claim 1, wherein the plug comprises a screw in fit into the aperture.

7. The fuel nozzle system of claim 1, further comprising a plurality of variable orifice plugs.

8. A combustor for a gas turbine, comprising:
an end cap;
a plurality of fuel nozzles positioned about the end cap;
each of the plurality of fuel nozzles comprising a flange attached to the end cap; and
a plurality of variable orifice plugs positioned with the flange.

9. The combustor of claim 8, wherein the plurality of variable orifice plugs comprises a plurality of replaceable plugs.

10. The combustor of claim 8, wherein the each of the plurality of variable orifice plugs comprises an orifice therethrough.

11. The combustor of claim 10, wherein the plurality of variable orifice plugs comprise a plurality of differently configured orifices.

12. The combustor of claim 8, wherein the plurality of variable orifice plugs comprises a press fit into the aperture.

13. The combustor of claim 8, wherein the plurality of variable orifice plugs comprises a screw in fit into the aperture.

14. The combustor of claim 8, wherein the plurality of fuel nozzles comprise a plurality of removable nozzles.

15. A method of operating a combustor, comprising:
positioning a plurality of fuel nozzles about an end cap of the combustor;
flowing fuel through the plurality of fuel nozzles; and
replacing one or more of the plurality of fuel nozzles without removing all of the plurality of fuel nozzles.

16. The method of claim 15, wherein the plurality of fuel nozzles comprises a plurality of variable orifice plugs and wherein the method further comprises replacing one or more of the plurality of variable orifice plugs.

17. The method of claim 16, wherein replacing one or more of the plurality of variable orifice plugs comprises varying a fuel flow volume therethrough.
